(19) United States
(12) Patent Application Publication
(10) Pub. No.: US 2004/0249666 A1
(43) Pub. Date: Dec. 9, 2004

(54) Healthcare system and a method of implementing same

(76) Inventors: Thomas S. Napolitano, West Babylon, NY (US); Daniel O'Neal Vona III, New York, NY (US)

Correspondence Address: Patterson Belknap Webb & Tyler, LLP, Attention: I.P. Docketing, 1133 Avenue of the Americas, New York, NY, 10036, US

(21) Appl. No.: 10/458,765

(22) Filed: Jun. 9, 2003

(51) Int. Cl. G06F 17/60

(52) U.S. Cl. 705/2

(57) ABSTRACT

The new healthcare system of the present invention uses Medical Advance-Practice Standard (“MAPS”) decision-making model for providing better patient care. MAPS model embodies the medical practice standard established by the best major medical hospitals and research centers. While providing the capability for fast, accurate, monitoring of the integrity of the physician-patient transactions, using computational science and simulation modeling, MAPS assists medical practitioners to diagnose and treat patients, and provides the basis for scientifically defensible and broad-based financial medical decisions.

### FIELD OF THE INVENTION

This invention is directed to a field of medical healthcare systems and the method of operation of the invented system in today's society.

### BACKGROUND OF THE INVENTION

Healthcare is a key component of the critical infrastructure of any country, consuming annually a large percentage of that country's economy. It is a complex system that also involves finance, politics and social engineering. Because all people are patients by nature, healthcare is also the most personal of issues. Healthcare exists today as a patchwork of wasteful, inefficient and often counterproductive institutional components. Its underlying economics are unsound and the current system cannot continue to operate without substantial subsidies. It is in crisis and this crisis is multi-dimensional. As a political issue, it dominates the national political scene and exacerbates already existing national political and social divisions. The healthcare system is critical to the internal security of a nation and the safety of its citizens. Over the last thirty years, hundreds of billions of dollars have been wasted in vain attempts to find “quick fix” solutions to the shortcomings of that system. The net result of both private and government action has been the continual escalation of medical costs that now threatens the standard of living of all citizens. The present ad hoc and inchoate system continues because of the lack of a viable alternative.

This crisis extends beyond the institutions of the system to the practice of medicine. At present, medical practice at top tier institutions is prescience-based, dependent on the insight, intuition, experience and training of excellent attending physicians. However, as one descends the hierarchy of medical care, prescience is diminished and the validity of this model comes increasingly into question. In high-pressure situations, such as occur in emergency rooms, reliance on prescience-based medical practice increases the risk of human error. Additionally, the new field of computational biology, reflected in research programs, such as the mapping and sequencing of the human genome and the molecular blueprinting of the bio-chemical activity of human organs, is adding new dimensions and complexity to the scientific roots of medicine. Research is driving medical practice into an era of constant dynamic change, producing new information at speeds that challenge the ability of even top tier medical practitioners to absorb and process it.

Today's a non-curative, market-driven, pharmacological model of medicine, represented by Health Management Organizations [HMOs], has failed to render quality service or control ever-rising costs, and has proven hostile to patient needs and medical advancement. Managed care has become damaged care.

The scope and magnitude of the system and its problems obscure the underlying causes of the current crisis. What is needed is a knowledge-based, curative healthcare system. The new system must make full use of the powerful tools of modem science and transform healthcare to a system that meets the needs of the post-modem age. This new system must replace the following core functions of the current (“prior art”) healthcare system and must provide:

1) Medical decision-making;

2) The management of information flows throughout the system;

3) Monitoring the integrity of the system; and

4) Collection of premiums, rate setting and reimbursement to providers (this function is necessary not for the technical aspects of the new system, but for the financial imperative and the method of implementing the system.)

Thus, clearly a new system is needed to eliminate the inequities and inadequacies of patient care provided by the prior art system. Therefore, an object of the present invention is to develop a healthcare system that provides a knowledge-based methodology of diagnosis, treatment, and aftercare.

Another object of the invention is to develop a system that provides physicians and hospitals and the research community with an improved access to the information generated through the knowledge-based methodology.

Another object of the invention is to develop a system that provides a financial component, based on “lifetime averaging,” that eliminates the transactional layers and their concomitant costs of the prior art system.

Another object of the invention is to develop a system in which the patients are also part owners. The financial component must assure that the best medical practice is the most fiscally prudent, and that knowledge derived from patient care accrues to the medical and financial benefit of an individual as a patient and as a part owner.

Another object of the invention is to develop a system that provides necessary data and information flow during individual, regional, and national emergencies.

Another aspect of the system is to provide the information base and broad-based clinical trials capability essential to medical research and development.

Another object of the invention is to provide a business model for a healthcare system that uses computational science and simulation modeling and applies medical advanced-practice standard for patient diagnosis, treatment, and care.

Yet, another object of the invention is to develop a healthcare system that can generate revenue from its various components.

### DESCRIPTION OF THE DRAWINGS

FIG. 1: MAPS object modules;

FIG. 2: Patient module;

FIG. 3: Disease module libraries and arrays;

FIG. 4: A detailed view of Disease module's libraries and arrays, and the various data sets;

FIG. 5: Diagram showing physician's access to the various disease data sets;

FIG. 6: MAPS elements used to generate patient forecasts;

FIG. 7: Diagram illustration the elements of patient screening process;

FIG. 8: Diagram illustrating the process of identification of disease syndrome;

FIG. 9: Diagram illustrating the expansion of the Disease module;

FIG. 10: Digital network of the healthcare system of the present invention;

FIG. 11: Various platforms of the network of the present invention;

FIG. 12: Diagram illustrating public access to PatMod repository files;

FIG. 13: Diagram illustrating public access to Trust and Account data file of FIG. 12;

FIG. 14: Diagram illustrating public access to patient archive, calendar, and help desk files of FIG. 12;

FIG. 15: Diagram illustrating functional integration and security classification for different platforms within the network of the present invention;

FIG. 16: Business model of the Company of the present invention;

FIG. 17: An alternate view of the business model of the Company of the present invention.

FIG. 18: Business model of the system of the present invention.

### DETAILED DESCRIPTION OF THE INVENTION

The new healthcare system of the present invention uses Medical Advance-Practice Standard (“MAPS”) decision-making model for providing better patient care. MAPS model embodies the medical practice standard established by the best major medical hospitals and research centers. While providing the capability for fast, accurate, monitoring of the integrity of the physician-patient transactions, using computational science and simulation modeling, MAPS assists medical practitioners to diagnose and treat patients, and provides the basis for scientifically defensible and broad-based financial medical decisions. In MAPS, computation means the action of a Turing-type machine, that is, the operation of a computer according to some computer program having well-defined logical operations. In the preferred embodiment, MAPS is written in C++ computer language for the Win32 platform. It may also be advantageous to use another computer language, such as Java, so that MAPS could be ported to Linux/Unix system, thus assuring universal server side and client side support.

In the preferred embodiment, the new system is administered by a private, for-profit entity (the “Company”). The Company is a content, service, and content-applications provider, and a third-party administrator. The system's provision of medical services, such as payments and patient subscriptions is made through a mutual company or business trust (the “Trust”), which provides healthcare coverage to patients (participants) enrolled in the new system based on the concept of lifetime-averaging of medical costs. Thus, the Trust, which is explained in more detail below, is a dominant guarantor in this environment.

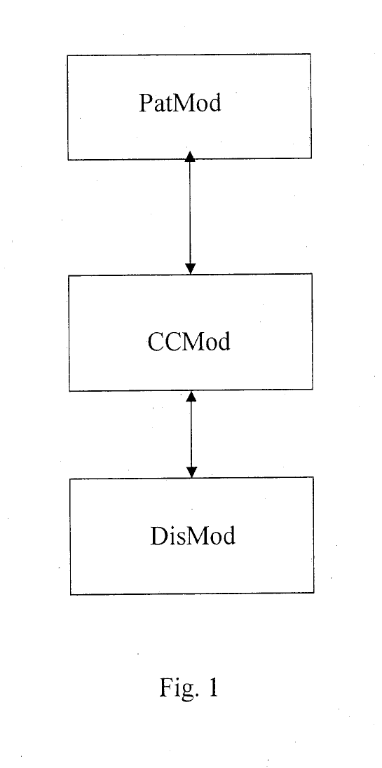

As shown in FIG. 1, the MAPS program is broken up into three “object” modules operating in tandem. The three modules are: the Patient module (PatMod), the Disease module (DisMod), and the Control module (CMod). In order to provide the best and cost-effective medical treatment, the Control module may also include a Cost component, and be called a Control and Cost module (CCMod).

PatMod:

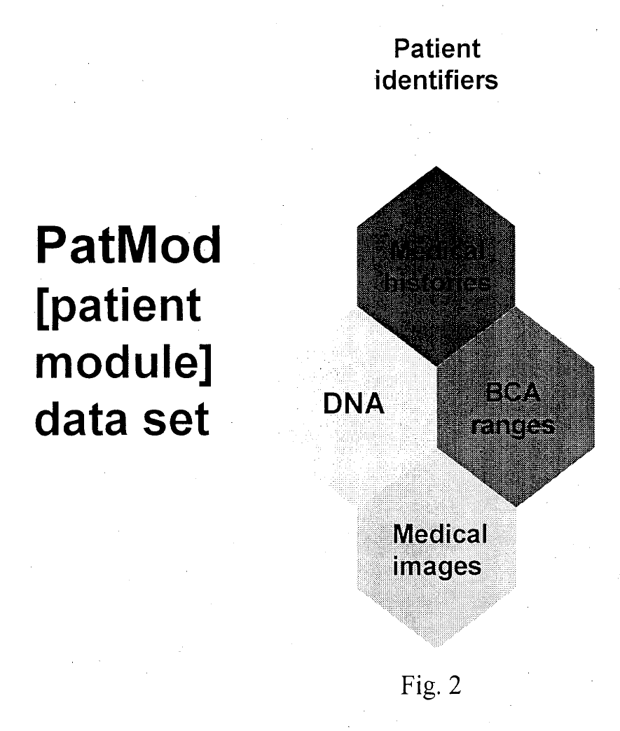

The Patient Module (PatMod), shown in FIG. 2, is a scalable “object” used to encapsulate data regarding each individual patient. The PatMod includes patient information (“identifiers”), such as name, address, telephone number, date of birth, occupation, education, Social Security Number, extended zip-code, physician, narrative, medical history, syndrome of symptoms, and DNA profile. Due to their scalability, the identifiers are easily adjusted to include information as abstract as a patient's statistical position (given a case study), or as precise as a patient's genome map. PatMod can be built using techniques well known in the art of electronic archive building, such as the ones described in “Principles for Digital Library Development” by McCray, Alexa T., Marie E. Gallagher.

DisMod:

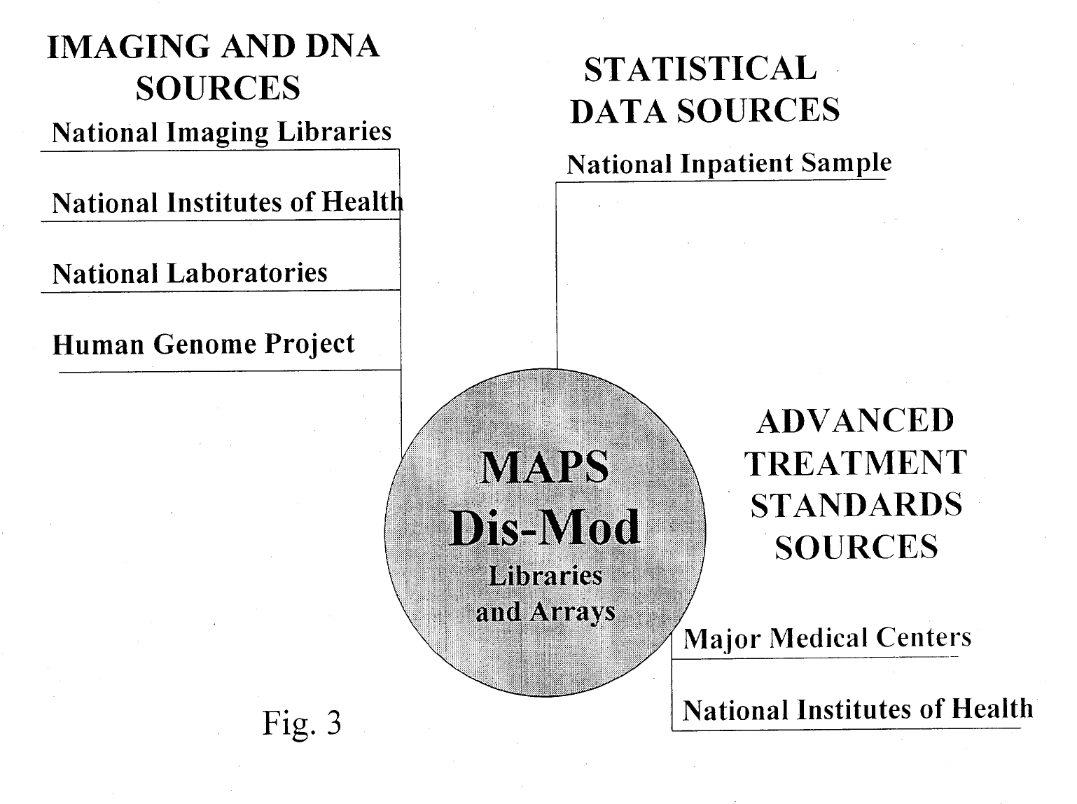

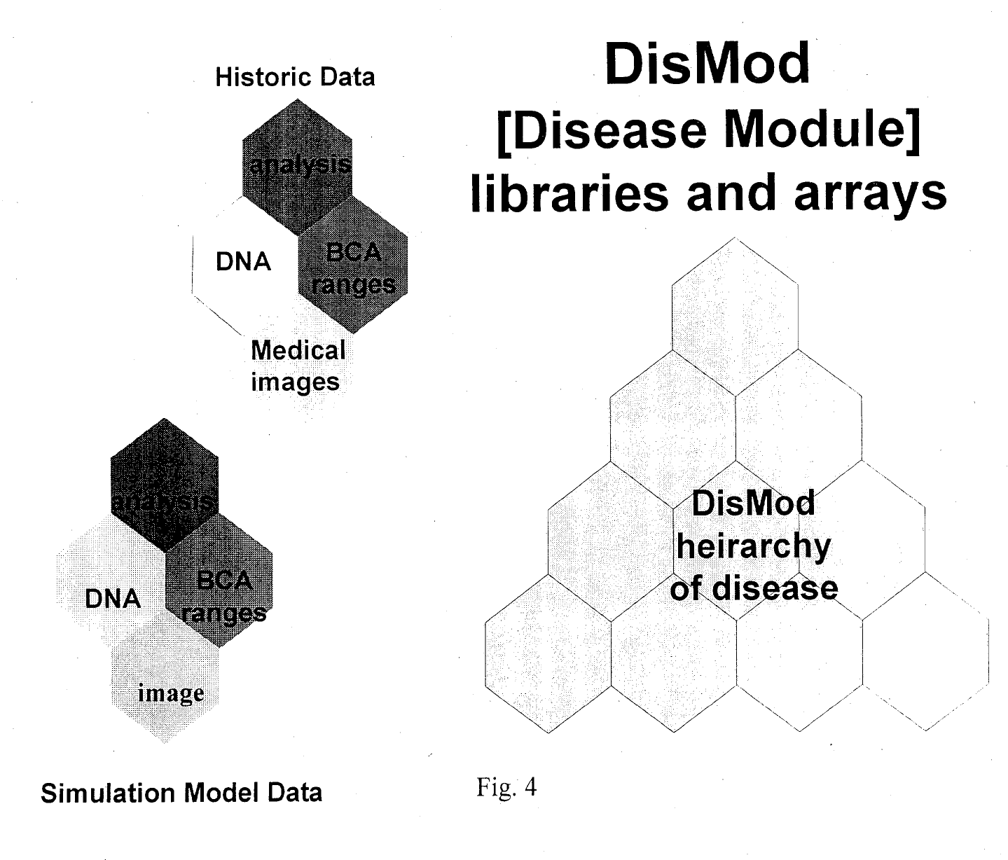

The Disease Module (DisMod), partly shown in FIG. 3, is an “object” that handles all references to the health information in an external database. The external database is an amalgamation of medical information encompassing medical texts, premiere medical journals, and other medical materials. Using a “tree of pointers” to an arrays of diseases, all in a predetermined order of frequency, such as descending order shown in FIG. 4, the DisMod can be structured as a hierarchy of disease types organized by a predetermined “frequency of occurrence.” For example, for Heart Disease, the sub hierarchy is Coronary Artery Disease, Congestive Heart Disease, Abnormal Heart Rhythm Disease, and so on.

DisMod also contains diagnosis and treatment functionality. Based on a master list of symptomatic information, all disease objects can be indirectly referenced to syndromes of symptoms in the list. The information regarding a patient's syndrome is examined by the DisMod's query functions, and a list of pointers to the relevant key terms is returned. The syndrome of symptoms information referenced in the PatMod is itself a filtered list of pointers to relevant key-terms. This filtering can be handled by internal PatMod filtering algorithms and stored as an array member variable. This allows faster diagnosis-update processing.

As also shown in FIG. 4, the DisMod can contain a library of simulation models of “normal” images of organs and “normal” biochemical-activity range tables corresponding to those models. This allows a patient's biochemical activity profile to be compared and contrasted with the range tables. The DisMod's functions can traverse the disease hierarchy and return relevant diagnosis information and identify anomalies. Diagnosis information and anomalies are passed on according to predetermined protocols and linked to a separate treatment list. As a result, preferred treatments can be displayed and custom treatments developed. CCMod:

The Care and Cost (CCMod) module handles information regarding the care and after care services, and the cost of care for different healthcare treatments. CCMod member functions link information stored in a patient's treatment field to the information stored in the CCMod's service information arrays. The cost for any given treatment, care and after care (or any combination of treatments, care and after care) options can easily be determined. All procedures, tests, personnel (medical, technical, support and administrative), and other than personnel services [OTSP] expenses, such as medical and non-medical supplies, equipment, maintenance and so on, are identified in any known information storage medium, such as “bar-codes,” and logged for accounting purposes and integrity control.

Physician Interface:

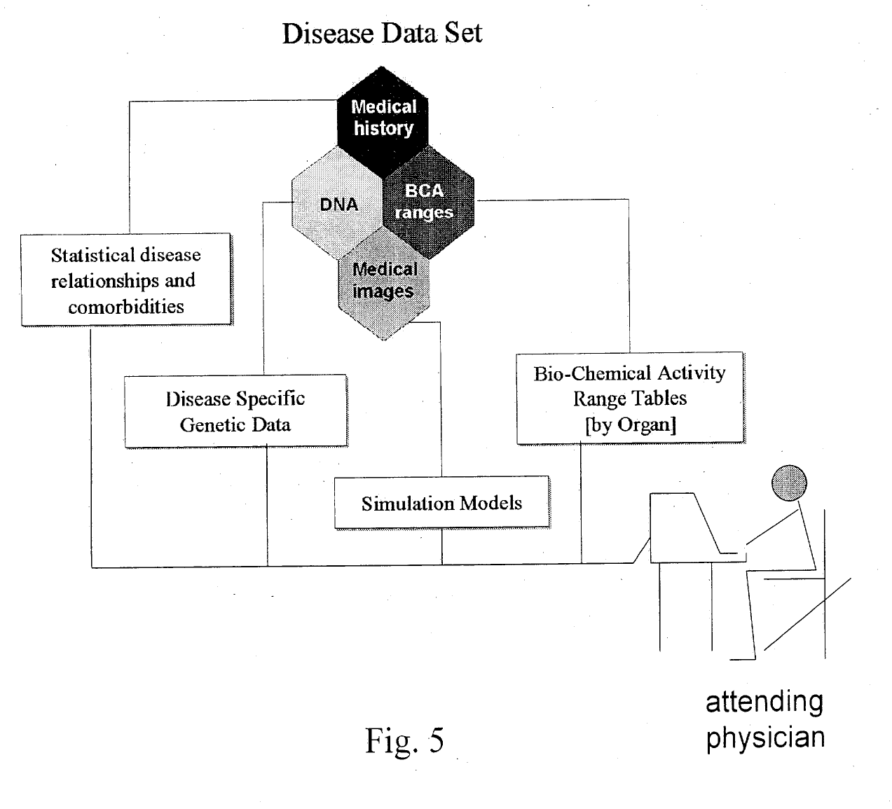

Attending physicians have access to MAPS via a secure interface, shown in FIG. 5. The interface provides for the collection, correlation and analysis of patient data with the MAPS models, and for the distribution of MAPS diagnosis, treatment, care and aftercare recommendations to physicians.

Patient Care:

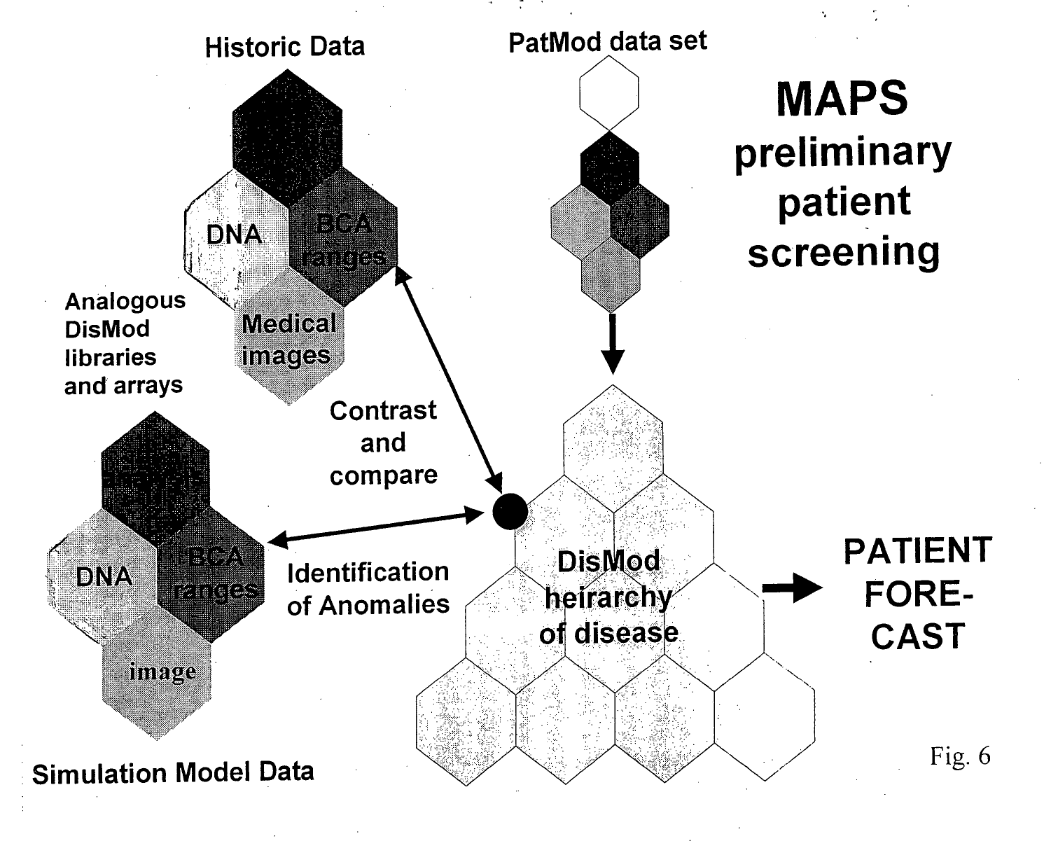

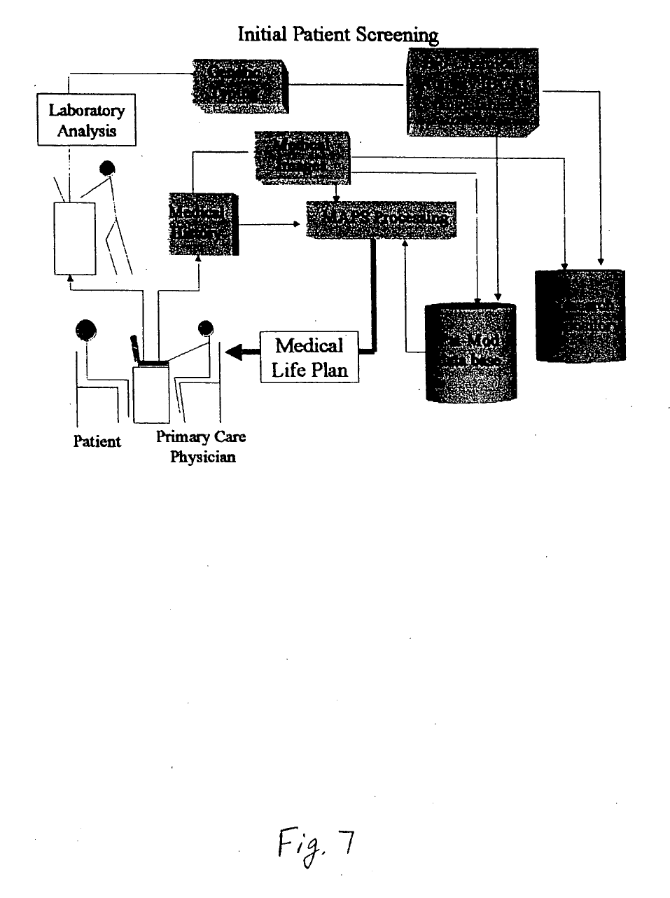

Using the MAPS model, patient forecast is achieved in the manner depicted in FIG. 6 and includes any of the elements and processes illustrated in FIG. 7. Patients are first screened and their PadMod data sets are created or updated with the latest information and symptoms. Initial patient processing, for example, may include testing patients for their bio-chemical activity [BCA]. In such cases, MAPS compares patient BCA data to Simulation Model Ranges [SMRs] stored in the DisMod. Variances from SMRs act as alarms for possible disease symptoms and are then processed by DisMod for the presence of disease syndromes. Treatment may indicate the need for further tests utilizing medical imaging processes such as MRI and CAT scans. Because each patient is unique, medical images of organs such as the brain vary from patient to patient. To give meaning to imaging, the system simulator creates a simulated golden standard image. This image mimics the image of a normal organ. Because the individual idiosyncrasies, called anomalies, are not present in the simulator model, the image is clearer and more precise than an in vivo (“live”) organ would appear. Simulator model images accessible through DisMod give the physician a clear frame of reference for visual comparison with in vivo images. Thus, imaging, used in the described manner described above and when used in conjunction with other DisMod features, such as processing of biochemical analysis, becomes a valuable diagnostic tool. Based on the patient screening, the system can generate a “patient forecast” report, a “snapshot in time” detailing where the patient is at any given moment on their medical lifeline. The patient forecast provides the basis for a medical life-plan that can be devised by the attending physician in consultation with the patient.

The following scenario provides an example of the new system's ability to maximize the benefits of modem technology and to justify the costs of investment in new medical equipment: A patient's biochemical analysis shows an organic or functional condition indicating the presence of disease, which lead the attending physician to postulate that the symptom is related to the liver. An aspect of the normal functionality of healthy liver is enzyme production. Biochemical analysis has identified the normal range of enzyme production in a healthy liver. A table of acceptable ranges of enzyme production for the liver can be drawn. If the physician made a correct preliminary diagnosis, a visual comparison of the suspect in vivo liver MRI and the simulator model MRI will confirm the diagnosis and identify the specific area of the affected liver. If surgery is required, the surgeon knows, before the operation commences, the exact location of the affected area. As a result, surgery can be more precise, less invasive, and the probability of success and speedy recovery can be improved.

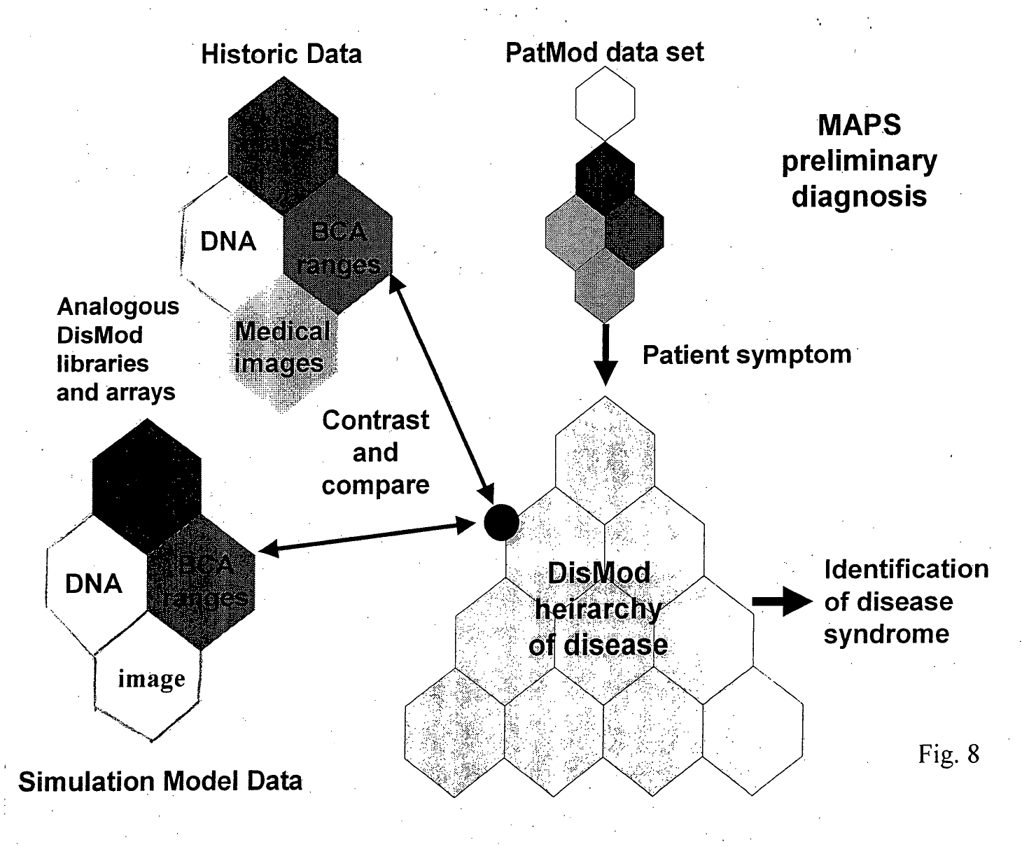

As pictorially shown in FIG. 8, the present invention can use high-speed search, analysis and correlation capabilities to process the input of patient symptoms (an organic or functional condition indicating the presence of disease, especially when regarded as an aid to diagnosis) to search for the presence of syndromes (an aggregate or set of concurrent symptoms together indicating the presence and nature of a disease), and to correlate the results with the DisMod phenomenological indicator and disease behavior arrays.

In the new system, patient data is stored in a secure patient data repository that is independent of attending physicians. Approved medical providers have continuous remote access to this repository. The patient data repository feature simplifies physician record keeping and eliminates the need for costly duplications and delays that today is the common practice when patients change physicians or when a specialist is needed. Furthermore, patients are assured that every medical decision, even those taken in emergency situations, will be based on the most complete data.

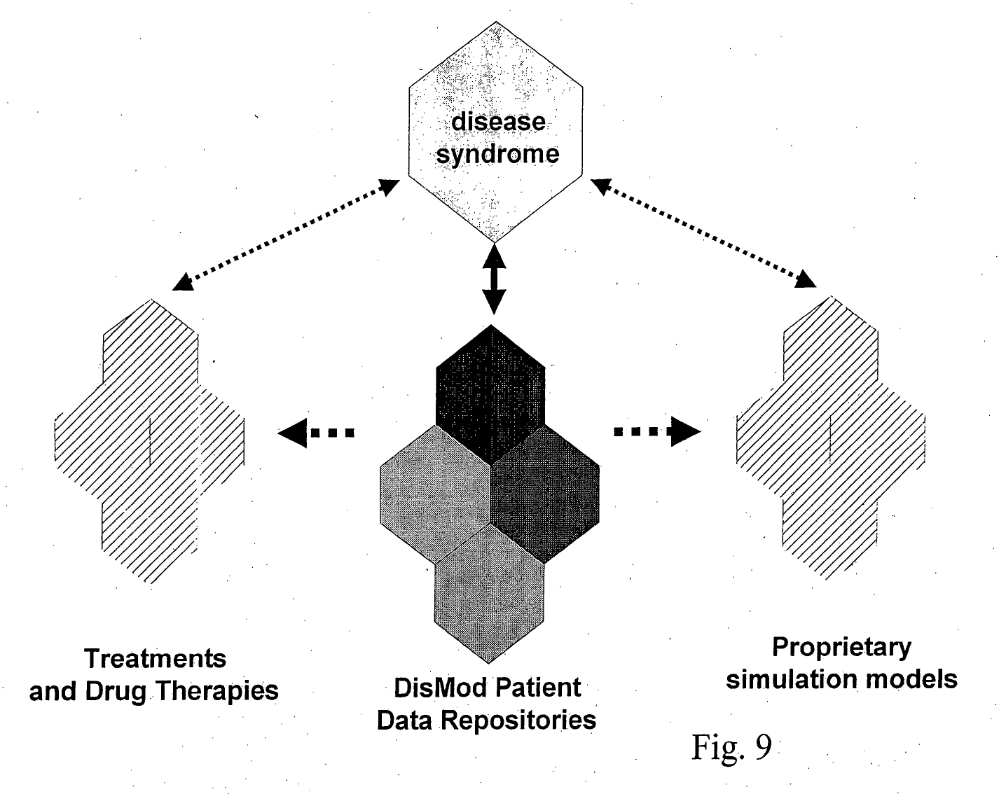

The new system also provides medical researches and medical teaching institutions with an extensive clinical trial base. With patient identifiers removed, the system can give the researchers almost real-time oversights of actual patient treatment without compromising patient privacy. As depicted in FIG. 9, the results of medical research can enable the system's DisMod module to be expanded to include the new databases of treatments and simulation models.

Digital Network of the New Healthcare System:

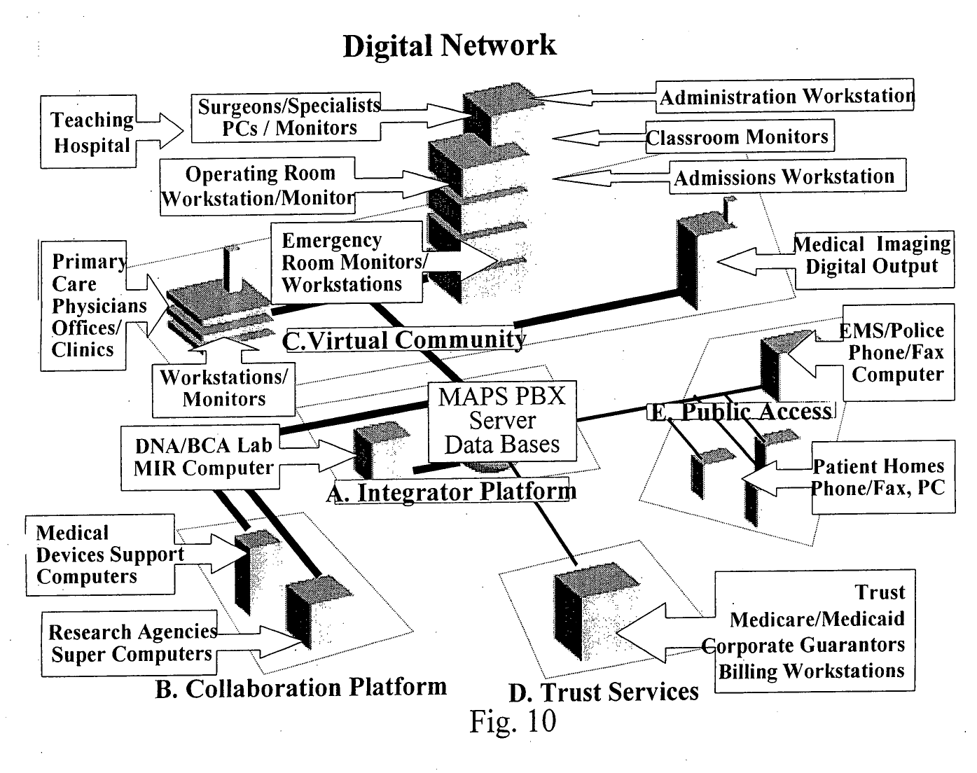

The new system is composed of a network of networks that support multiple interacting environments, work groups, user groups and platforms, in which MAPS serves as a central node for communication with the remote nodes. Such network architecture is depicted in FIG. 10. In the figure, MAPS is shown as a central node communicating with physicians, laboratories and hospitals via a broadband communication channel, and also communicating with the Patients and EMS/Police via a phone/fax or internet channels. Each of the remote nodes, a hospital for example, can include a number of internal networks. To provide user group access to the functions and services of MAPS, the system uses “private” or “closed” Extranet and Intranet derivatives of public Internet technology. To insure system integrity and security, proprietary software and groupware programs control access by user groups within specific environments to specific data partitioned in the MAPS data repositories. This design provides for the openness and connectivity of Internet technology with the speed and security of Extranet and Intranet technologies. The design also permits the resources to be accessible to any designated user group such as Emergency Medical Services [EMS] in times of regional and national emergencies.

Integration Platform:

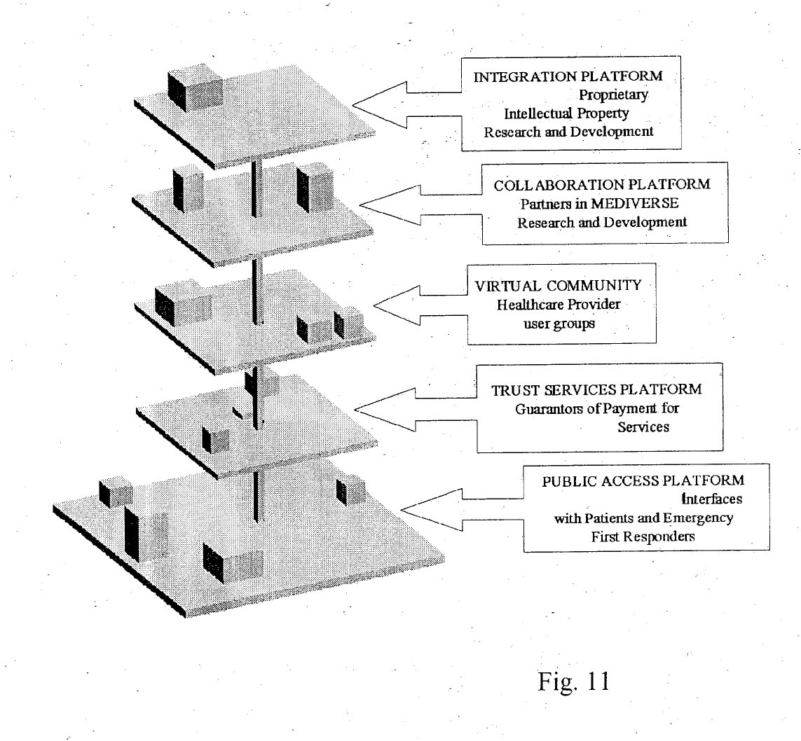

The network can be envisioned as being composed of different hierarchical platforms, shown in FIG. 11. At the top of the hierarchy is the Integration Platform. The level of access by the Integration Platform to MAPS is the highest in terms of multiplicity of functions, level of integration, and degree of security classification. Only members of this platform have access to the complete suite of cumulative data developed by MAPS. Use of this complete data can be restricted to the designated Medical Information Research [MIR] projects such as the development of proprietary treatments, drugs and therapies. In the preferred embodiment, a system administration program prevents public access to MIR. Encryption and private-key management programs regulate access to MIR from within the system.

The Integration Platform environment is domicile not only to MIR data storage and computer operations, but to the specified clinical operations as well. The storage of biological specimens such, as umbilicus material is also performed within the Integration Platform environment. In addition, Integration Platform environment can also house and direct DNA and Bio-Chemical Activity data.

Collaboration Platform:

The next platform down the priority chain is a Collaboration Platform. The Collaboration Platform is designed for access to MAPS for the research organizations that have contributed to the MAPS development. This platform serves as the vehicle for the cumulative cross-fertilization of information central to medical advancement. In return for cooperation with the formation of the MAPS libraries and arrays, these research organizations are given access to specified system information, such as specified reports and forecasts. The Collaboration Platform is an extended enterprise, a “closed user group.” Linkage between the Integration Platform MIR and selected Collaboration Platform partners is provided by “groupware” designed to enhance communications, collaboration and coordination for joint endeavors such as computer sharing to accelerate completion of complex mathematical computations. This “pipeline” is also designed to permit almost “real time” monitoring and oversight of patient care for which select Collaboration Platform organizations have particular public health interest, such as monitoring the effectiveness of new vaccines. The functionality of this platform dramatically reduces the time lags in patient monitoring studies. This pipeline can also serve as a direct link to government agencies for transmission of health alerts and alarms that may become evident by the system's continual internal audit functions of MAPS.

The Technology Community is a sub-group of the Collaboration Platform. This community is comprised of the corporations and research groups whose enterprises include the various technologies utilized by the new healthcare system, including telecommunications, data and image transmission, digital equipment manufacture, and computer and software technologies.

Virtual Community Platform:

The Virtual Community platform is the most broad-based, product-rich, and heavily trafficked environment in the new system. To this community flow the diagnostic, treatment, aftercare, and workflow management and billing products supplied by MAPS. Levels of access and the range of services are incorporated into the packaging arrangements with specific subscribers. Speed and quality of access is regulated by a wide range of Internet and Extranet bandwidths that accommodate data, such as records and real time video streams for medical images. Centralization also affords much higher degrees of system integrity and security. MAPS's Patient module provides off-site storage and accessibility of patient records. This eliminates the present-day costly practice of test and procedure duplication, permits “seamless” change of physicians and hospitals by patients, and saves valuable time, particularly in emergency situations.

Trust Services Platform:

The Trust Services Platform is depicted in FIG. 11, and is comprised of the payment guarantors for the system's services. Operation of the Trust is described later in the specification.

Public Access Platform:

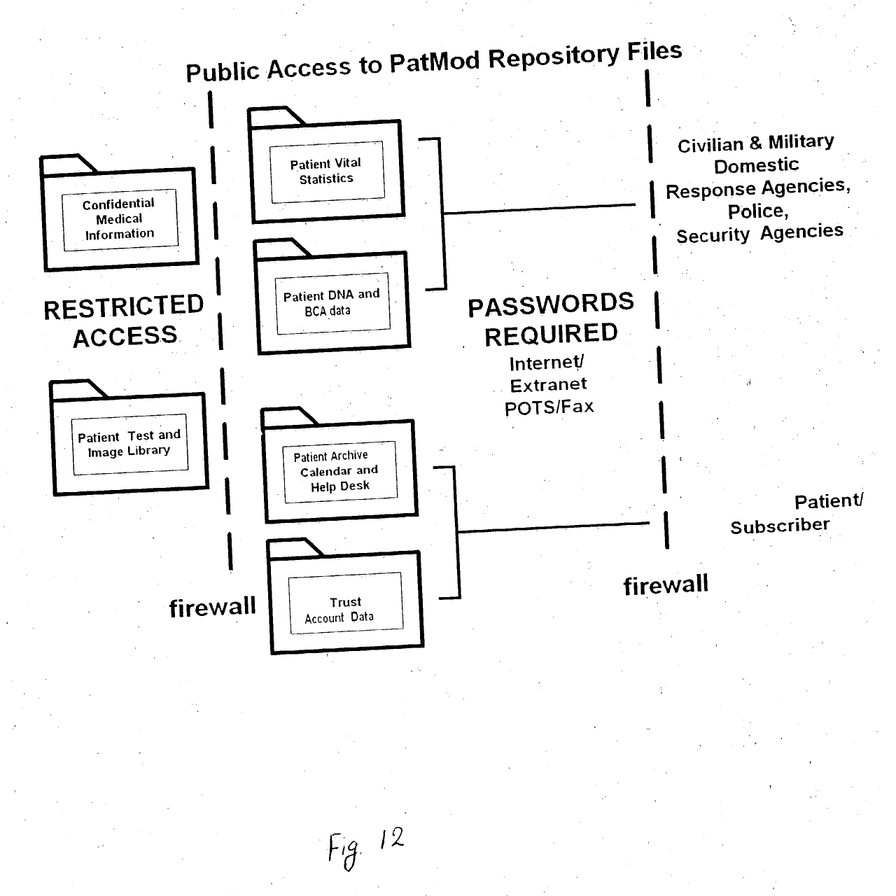

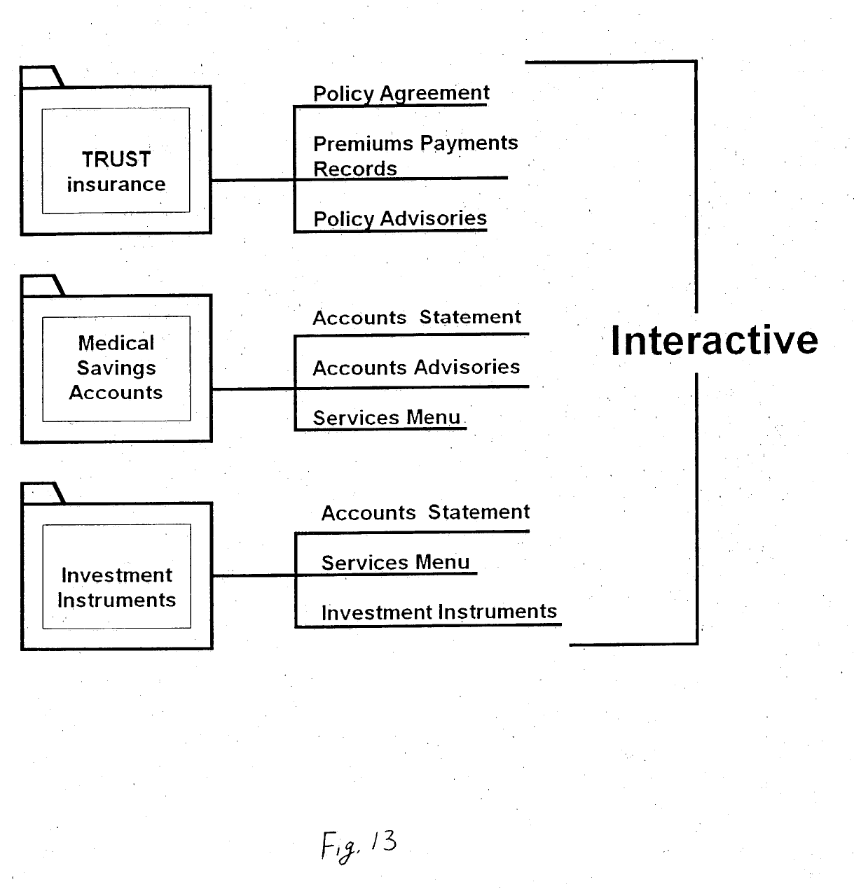

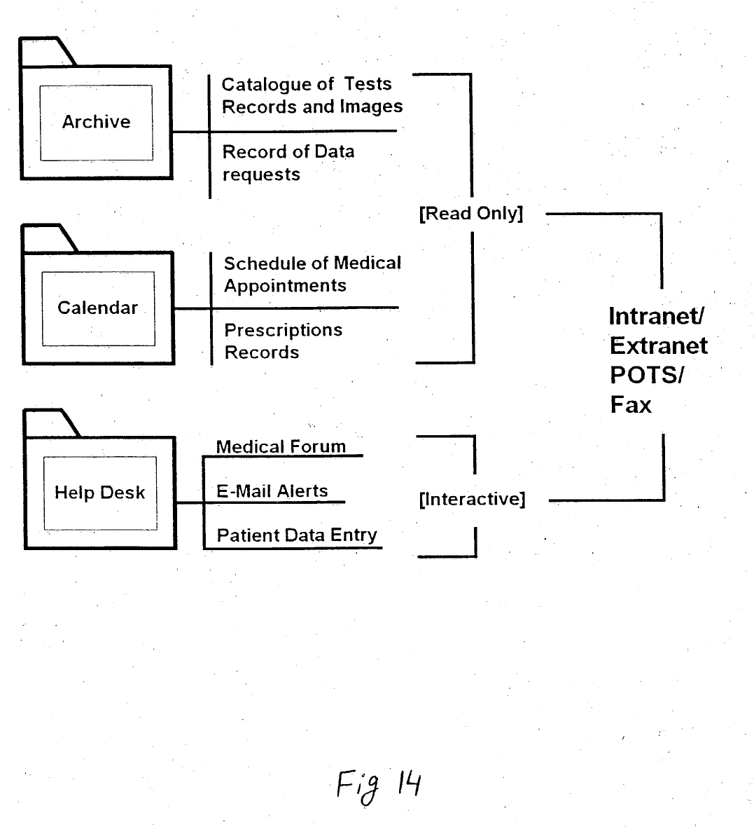

The Public Access Platform provides multi-tiered and partitioned access for a wide range of users to the patient files stored in MAPS's Pat-Mod Repository for two major user groups, domestic response/security agencies and the system's patient/subscriber base. FIG. 12 illustrates public access to the system's PatMod repository files. FIGS. 13 and 14 provide a more detailed view of the access to “Patient Archive Calendar and Help Desk” and the “Trust Account Data” files of FIG. 12.

Domestic Response Agencies

The Public Access Platform provides access for emergency, security, and law enforcement agencies to specific patient data, as may be mandated by applicable laws. This permits rapid access to vital medical information to aid in emergency response and DNA information for properly sanctioned investigations.

Password authorization provides access to the system's data pool for the EMS, law enforcement, military, and security agencies that form the basis of the regional and national domestic response charged with providing first and second response, guidance and direction in cases of natural disasters and other emergencies. This platform provides data necessary for positive identification of the victims and the injured, as well as patient information vital to medical emergencies. In criminal cases, the platform provides data for possible suspect identity verification.

In cases of emergencies, the system links Public Access Platform with the Collaboration Platform and forms a comprehensive National Defensive Response Platform.

Patient Access

The two major patient files in this environment are the patient medical information files and the patient financial files.

Particular attention is paid to facilitate telephone access for seniors who have been the least “web friendly” to the Archive, Calendar and Help Desk menus and services. For example, an important financial consideration in realizing cost savings for Degenerative Disease treatment involves “home testing” for health readings such as Cholesterol, blood sugar and blood pressure levels. These home readings are transmitted to the patient's attending physician. The system provides telephone access to the interactive Help Desk functions. The patient “keys in” readings by touch-tone or voice activation telephone functionality. These readings are automatically entered into the patient's electronic clinical chart stored in Pat-Mod. Readings outside pre-set BCA ranges automatically trigger an electronic alarm to the attending physician so that a swift action can be taken.

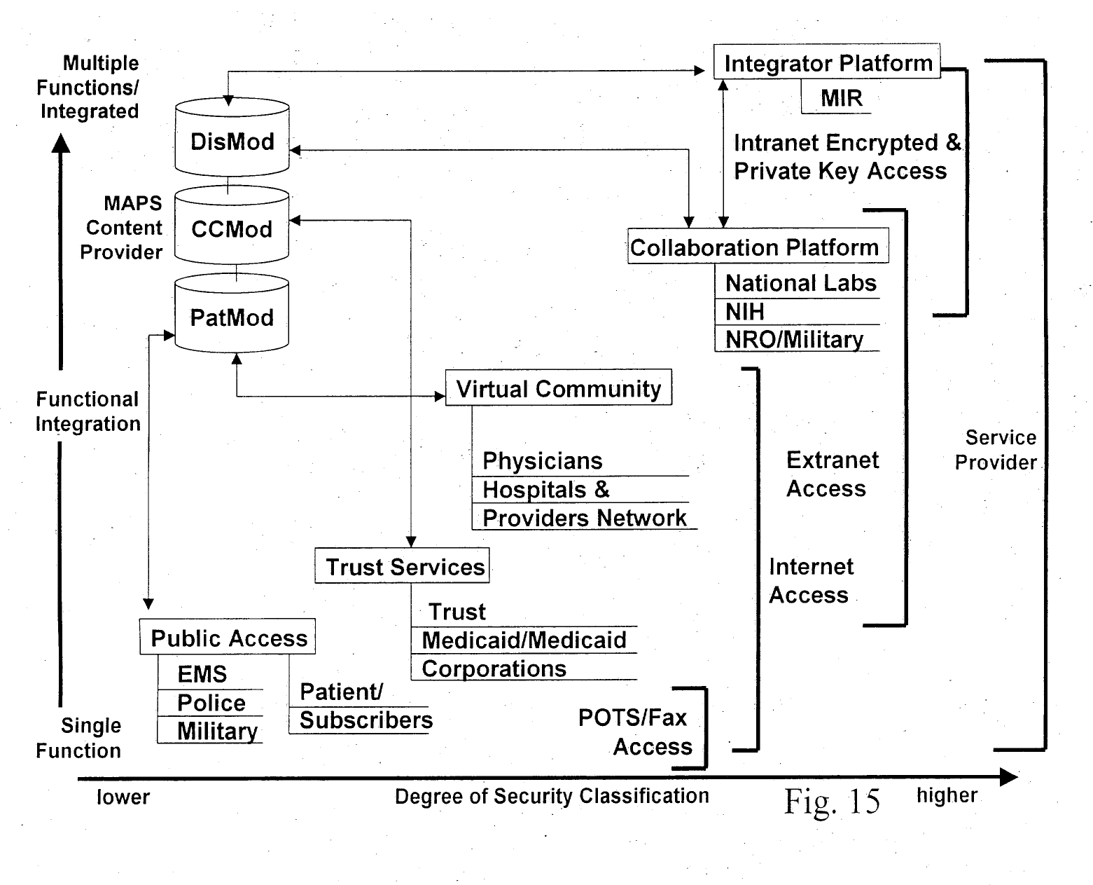

FIG. 15 illustrates the relationship between functional integration and security classification for different network platforms disclosed above.

As is clear from the foregoing disclosure, the new system's automated processes provide proprietary methodology of diagnosis, treatment and aftercare, transactional integrity monitoring, billing and reimbursements, access to MAPS for physicians and hospitals, and mobilization and direction of available assets and information in cases of regional and national emergencies.

Following is an example of the operation of the invented healthcare system in an emergency situation:

EXAMPLE: A 911 call is received by Emergency Medical Services [EMS] on a busy Saturday night. A man has been found alone on a city street, semi-conscious and gasping for breath, indicating a possible heart attack. An ambulance is dispatched to the scene. A health insurance card and driver's license are found on the man. The card employs “smart card” technology that permits pre-loading the card with patient vital statistics such as name of next of kin, identity of attending physician, present medical conditions, current medications, and warning indicators such as history of allergic reactions. This information can be extracted by swiping the card on a specially designed portable “reader” or by logging on to MAPS via the system's web site. In this case, the on-site EMS personnel relay the patient's system number to the hospital ER. ER logs onto the system's web site and within seconds, the patient's PatMod data resides on the ER computer for review by the attending resident. The resident telephones orders to EMS personnel on site. These orders are based on a complete familiarity with the medical history of the patient. Data drawn from on-site EMS examination is entered into MAPS and a preliminary diagnosis and recommended treatment is rendered. The resident renders a judgement, based on complete data, that emergency surgery is needed. The resident orders EMS personnel to redirect the patient to another medical center, bypassing the local hospital entirely. As the resident telephones the medical center to inform them of the patient's imminent arrival, the resident enters the medical center access code on the system's screen, hits the SEND TO button and the system does the rest.

Before the ambulance arrives at the medical center, an alert has been sent by e-mail, fax or phone to the patient's attending physician. The physician reviews the data transmitted by EMS via wireless channel to MAPS on his home computer. At the same time, the complete PatMod data has been received by the medical center on-duty resident. As it happens, the chief surgeon at this moment is at home where he is reached by telephone. The surgeon logs onto the system via a laptop and within minutes is reviewing patient history. The patient's attending physician, the on-duty resident and the chief surgeon consult via Instant Messenger. The fourth leg of the consultation team is MAPS diagnostics. Agreement is reached to conduct a specific ECCOSOUND test as soon as the patient reaches the medical center.

Upon arrival at the medical center, the patient is waived by Admissions and ER and taken directly to the ECCOSOUND facility where the technician is reviewing the patient's last ECCOSOUND test on his workstation. The technician joins the Instant Message group and is given specific instructions.

Meanwhile, MAPS automated processes have completed all pertinent patient information concerning admissions and insurance. The preliminary patient bill for services has been created on the Accounting Department workstations and the patient's electronic chart appears on the OR workstation computer.

While the test is ongoing, each member of the consultation team, although in different locations, view the streaming video produced by the ECCOSOUND test in real time as the test is happening. Retakes can be ordered on the spot while the patient is still being tested until the team is satisfied. The decision is made to operate, and the parameters of the procedure are decided.

Because the medical center subscribes to MAPS workflow programs, scheduling of resources for the operation is automated and all personnel necessary for the operation have been notified according to the business rules pre-set by the medical center.

MAPS live video feed capabilities permit the operation to be viewed by the patient's attending physician at home and by a class of medical students at a nearby teaching hospital.

Under the new system paradigm, nothing is left to chance . Every medical decision is based on the most complete patient data. The possibilities of misdiagnosis or misapplication of drugs are reduced while the chances of success are enormously improved. The strain on overtaxed ER facilities at both hospitals is lessened and thousands of dollars are saved. As a result, hospital administration costs are greatly reduced and the amount of paper records is minimized, or eliminated altogether.

Business Model

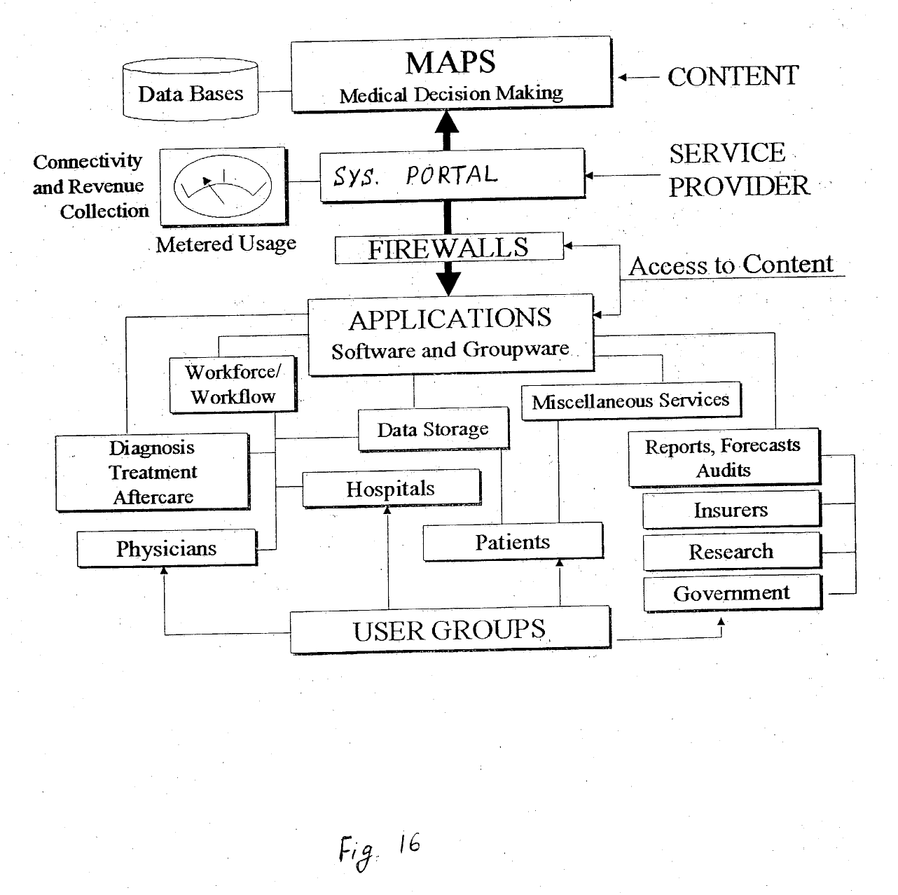

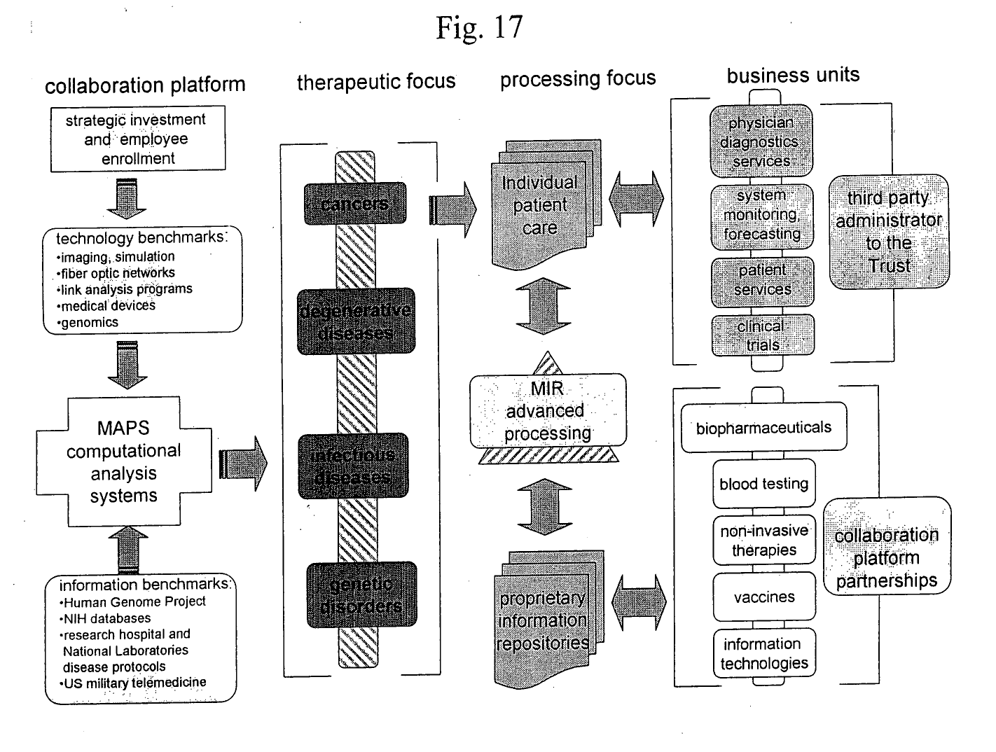

FIGS. 16 and 17 depict the Company business model.

The system content is composed of the proprietary computer programs and databases that comprise the MAPS medical decision-making processes.

The service component, the Company's Portal, is comprised of the access networks, the pipelines, through which MAPS information travels to the system user groups. The portal is also the system revenue collector providing for “metered usage” according to pre-set connectivity and “pay-per-use” schedules.

The content applications component is comprised of the proprietary software and groupware programs that regulate user group access to the network pipeline and content.

The Virtual Community provides the Company with its source of “fee-for-service” revenues. The Company provides access software that links subscriber systems to MAPS. The model encourages subscribers to turn over to MAPS centralized computer operations many of their daily operational functions. This model dramatically reduces the transactional layers that inflate the administrative costs incurred by the current healthcare model, while also providing substantial increases in treatment upgrades, efficiency of operations, reductions in non-medical staffing, and increase in net profits.

MIR intellectual property also provides a significant source of revenues. As an adjunct of the Company with access to the entire patient pool, MIR can have the broadest “sampling base” of any present research institution, pharmaceutical corporation, or government agency. As MIR intellectual property evolves into proprietary medicines and therapies, they will be introduced to the Company's patient database without today's high promotion and advertising costs, which can be greater than the research costs.

Information derived from the activities of the Integration Platform, described above, can also form the foundation for subordinate for-profit-research organizations. Where possible and prudent, MIR findings can be made available to outside institutions and corporations on a royalty basis.

Trust Services is another source of revenues for the Company. The new business model assures that the best medical practice is the most fiscally prudent and that knowledge derived from patient data and care accrues to the medical and financial benefit of the Trust's members.

By enrollment in the MAPS program and the purchase of the Trust's insurance coverage, patients become participants in the Trust.

Excess funds generated by the Trust are invested in medical research and technology sectors that demonstrate the promise of advancing medical knowledge and benefiting patient care.

The Trust uses information contained in MAPS patient data repositories, individually and collectively, to promote medical research and development, and enhance shareholder value.

In the performance of these functions, the Trust at all times protects the privacy rights of patients.

The Trust acts as premiums collector for the individuals and corporations who purchase medical insurance, and as payor/guarantor for providers who form the system's Virtual Community. The Trust can also pursue contractual agreements with government agencies that administer healthcare funds, such as MEDICARE and MEDICAID agencies in the United States, to administer public insurance programs under the Trust “lifetime averaging” concept and provide medical services under the MAPS methodology. Thus, the Trust occupies a unique relationship with the Company's business model. The Trust reimburses the Company on a contractual/transactional fee-for-services basis, and in return for the use by The Company of the intellectual property derived from its patient/subscriber base, the Trust is a participant in the profits derived from the commercial exploitation of such property by the members of the Integration Platform.

To the TRUST SERVICES platform flow the billing and audit reports generated by MAPS and to the Company flow reimbursements for services from the Trust.

Trust coverage works as follows. In place of the private insurance carrier family plan, the Trust treats each participant, including non-working spouses and dependents, as individuals. Families may be enrolled as a unit, but each family member has their own data repository and medical life plan and each has their own set of medical risks. Coverage rates are determined by the “life-time averaging” of the individual's anticipated medical costs. Family rates are the sum of individual member coverage rates. This provides an incentive for individuals to remain continually covered under the new healthcare system. Continual coverage dramatically reduces the transactional costs of health insurance. The application of lifetime averaging substantially reduces yearly premiums for all individuals when compared to the prior art “gap” insurance premiums. The most substantial savings under lifetime averaging are derived by the individuals who enter the new system as very young children. Their premium base rate is computed on the lifetime averaging based on their considerable life expectancy. As long as they remain enrolled in the system, their base rate remains constant. This leads to substantial savings in middle age, when family expenses are the highest.

Premium payments are the responsibility of the system participants. The self-employed pay premiums directly. In the case of employees covered by the employer insurance plans, employees may chose to instruct their employer to pay the premium directly to the Trust. In the alternative, the employee may receive the insurance premium amount set by their employer's present policy and pay the premium directly to the trust. If the individual's present day premiums deductions are higher than the costs of the healthcare premiums in the new system, the employee can accrue a positive account balance. This balance can be applied to cover premium payments during periods of unemployment, to defray expenses of elective medical treatment, or to accrue for payment of later expenses.

Patients also have an opportunity to acquire additional interests in the Trust. As a result, the Trust can act as a key element in the patient's overall financial planning. In addition to premium payments, patients' medical histories, records of current treatment, and genetic data are all asset that participants bring to the Trust. The Company can maximize the value of patient data repositories, individually and collectively, to medical advancement and, by doing so, increase shareholder value.

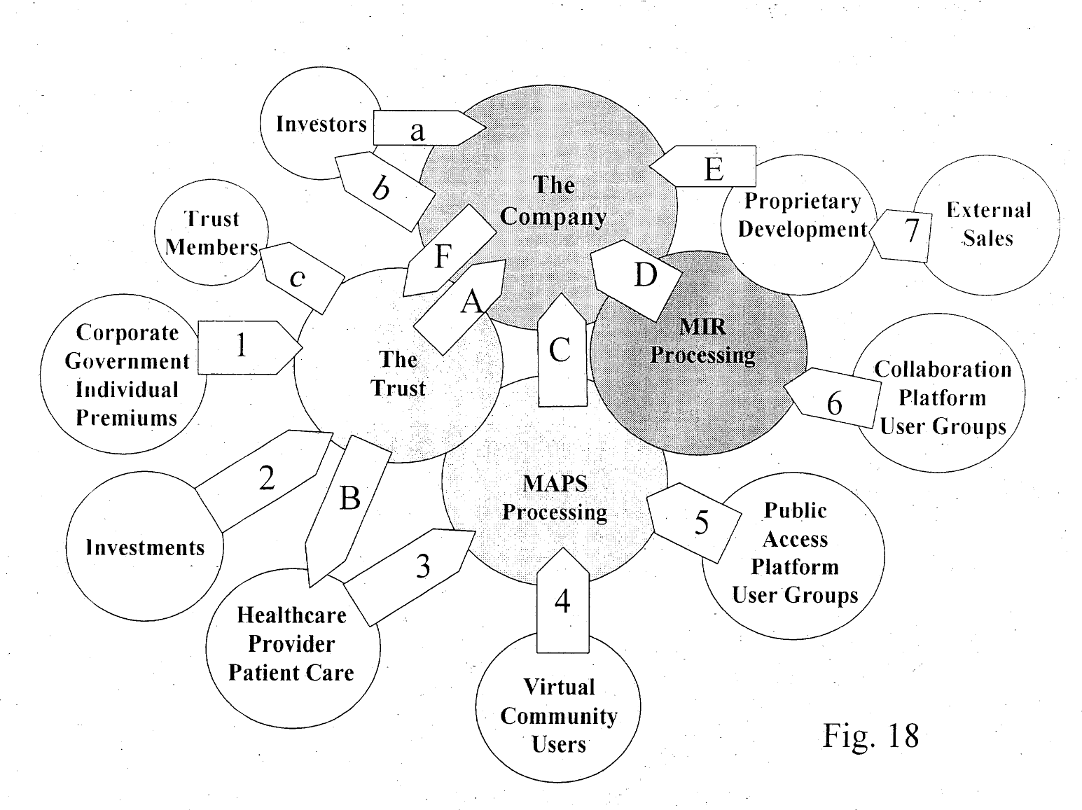

FIG. 18 depicts the overall system's business model, which includes operation of the Company and the Trust. Arrows designated with numerals represent royalties or revenues, generated by the system from third parties. Arrows designated with letters represent royalties or revenues flowing to, and from, the Company and the Trust. Company derives revenue at least from the following sources:

1. Royalty income, represented by arrow A, based on a monthly per member license fee paid by the Trust to the Company for use of Company diagnostics, data collection, processing technology and programs, and third-party administration.

2. Additional monthly per member charge royalty income for providing MAPS Third Party Processing, represented as arrow C.

3. Royalty income and revenue, represented as arrow D, for providing MIR Third-Party Processing.

4. Royalty income and sales income, represented as arrow E, from the system's Proprietary Developments.

5. Investment in the Company by third parties, represented by arrow a.

6. Profit distribution to third party investors, represented by arrow b.

The Trust has the following revenue/expense model:

1. Corporate, Government, and individual premiums paid to the Trust, shown by arrow 1.

2. Additional investments in the Trust by third parties, represented by arrow 2.

3. Royalty income from the Company, represented by arrow F, for providing the Company with access to the Trust-members' data. The Company processes this raw data and generates a proprietary information database that can be used for medical research and proprietary development projects.

4. Payments to healthcare providers, represented by arrow B, for medical services provided to the Trust members.

5. Profit distribution by the Trust to Trust-members, represented by arrow c.

The invented healthcare system and method are not limited to the embodiments disclosed above, and, as will become apparent to those skilled in the art, many changes and modifications can be made without departing from the spirit or scope of the invention. For example, the Trust can be replaced by a different business entity, such as a membership corporation, a mutual company, a limited liability company, or a closely held corporation. The Company could also be a public corporation, a membership corporation, a mutual company, or a limited liability company.

We claim:

1. A MAPS-data processing system comprising:
a Patient module configured to encapsulate data regarding each individual patient, including one or more of (a) name, (b) address, (c) telephone number, (d) date of birth, (e) occupation, (f) education, (g) Social Security Number, (h) extended zip-code, (i) physician, (j) narrative, (k) medical history, (l) syndrome of symptoms, and/or (m) DNA profile;
a Disease module including an amalgamation of medical information encompassing medical texts, premiere medical journals, and other medical materials; and,
a Control module that handles information regarding care and after care services, and costs of care for different healthcare treatments.
